(19) United States
(12) Patent Application Publication
(10) Pub. No.: US 2010/0010131 A1
(43) Pub. Date: Jan. 14, 2010

(54) Resin composition for medical use, resin pellets and part for medical use

(75) Inventors: Toshitsugu Nakahira, Saitama (JP); Tetsuo Kobayashi, Gunma (JP)

Correspondence Address: HAMRE, SCHUMANN, MUELLER & LARSON, P.C., P.O. BOX 2902, MINNEAPOLIS, MN, 55402-0902, US

(73) Assignees: Kaneka Corporation, Osaka (JP); SHOWA KASEI KOGYO, Saitama (JP)

(21) Appl. No.: 12/310,754

(22) PCT Filed: Aug. 30, 2007
(86) PCT No.: PCT/JP2007/066871

§ 371 Date: Mar. 6, 2009

(30) Foreign Application Priority Data
Sep. 11, 2006 (JP) 2006-245881

(51) Int. Cl. C08K 5/5419

(52) U.S. Cl. 524/261

(57) ABSTRACT

The present invention provides a resin composition for medical use, resin pellets, and a part for medical use obtained by molding this resin composition, having excellent radiation resistance in which discoloration significantly is reduced even during sterilization treatment using irradiation with radioactive rays, in particular, γ-rays. The present invention provides a resin composition for medical use comprising 0.1 to 15 parts by weight of a silane compound as a radiation resistant agent with respect to 100 parts by weight of a thermoplastic resin. The thermoplastic resin is preferably a polyvinyl chloride-based resin, and the silane compound is preferably at least one alkoxysilane compound selected from a monoalkoxysilane compound, a dialkoxysilane compound, a trialkoxysilane compound, and a tetraalkoxysilane compound. The resin composition may be a hard composition having a Rockwell hardness as defined in JIS K7202 of 35° or more, or may be a soft composition having a durometer A hardness as defined in JIS K6253 of 97° or less.

### TECHNICAL FIELD

The present invention relates to a resin composition for medical use, resin pellets, and a part for medical use using the same, having excellent color stability against a radiation sterilization method that uses γ-rays or electron beams. In particular, the present invention relates to a part for medical use having excellent color stability against radiation sterilization methods: such as parts used for the branching or connection of circuits for medical use, such as an artificial dialysis circuit, an artificial cardiopulmonary circuit, a blood circuit, or an effluent bag circuit; and a blood bag, an infusion solution bag, or various tubes for circuits.

### BACKGROUND ART

A part for medical use is required, for example, (1) to cause no harm to a human body through the elution of heavy metals or the like, (2) to have good usability in medical practice, (3) to be kept sterile until use, and (4) to allow the status of a contained fluid to be confirmed.

As a material that sufficiently satisfies these properties, a soft polyvinyl chloride-based resin composition is used. A soft polyvinyl chloride-based resin composition comprising a polyvinyl chloride-based resin and a plasticizer preferably is used in soft parts for medical use, such as a blood bag, an infusion solution bag, a dialysis circuit tube, and the like. Furthermore, a hard material such as a polycarbonate or polyolefin is used, for example, in an injector, a tube-connecting member, a branching valve, a flow-adjusting part, and other various parts connected to the above-described soft parts for medical use.

Conventionally, these parts for medical use are sterilized mainly using an ethylene oxide gas (hereinafter, referred to as EOG) due to the need for a high level of sterilization. However, since residual EOG after sterilization is carcinogenic, high-pressure steam sterilization is becoming more widely used instead of EOG sterilization in view of safety. However, in these sterilization methods, such as EOG sterilization and high-pressure steam sterilization, each packed article has to be individually sterilized, and, thus, there is a problem in that the sterilization operation requires a large amount of effort.

In order to perform the sterilization operation at a higher speed, the shift to so-called radiation sterilization methods, such as the cobalt 60-γ-ray sterilization method (hereinafter, referred to as γ-ray sterilization method) and electron beam sterilization method, that can perform sterilization after packaging, which leads to a reduction in cost, has rapidly progressed since the 1980's. Of these radiation sterilization methods, the electron beam sterilization method is advantageous in that a large number of parts can be subjected to such sterilization treatment in a short time, but is problematic in that the transmission power is small, sterilization tends to be non-uniform, and sterilization easily can vary from lot to lot. Conversely, the γ-ray sterilization method is advantageous in that sterilization is performed uniformly, because the irradiation time is long, but is problematic in that the color of the parts involved changes significantly.

A change in color due to radiation sterilization may cause so much discoloration that it makes it impossible to distinguish the colors of each part for medical use from each other, thereby inducing medical accidents such as taking the wrong parts by mistake. Accordingly, there is a limitation on using, in a part for medical use, a material that will be discolored by radiation sterilization.

As described above, discoloration of a part for medical use due to material deterioration is a serious technical problem in the field of the art, and various approaches have been made in order to solve this problem.

A soft polyvinyl chloride-based resin composition can improve these discoloration problems to some extent, and currently is used as a material that has excellent radiation resistance in the case where electron beam sterilization is applied. However, this soft polyvinyl chloride-based resin composition does not substantially solve the discoloration problems, and, thus, there has been a demand for a soft polyvinyl chloride-based resin composition that can resist γ-ray irradiation, which is a stronger form of sterilization.

Conversely, for example, a polycarbonate resin and an olefin resin that have relatively good γ-ray resistance are used in hard parts for medical use. A polycarbonate resin is relatively stable against γ-rays, and is becoming widely used in the case where γ-ray sterilization is applied. However, these resins are problematic in that the chemical resistance is poor (e.g., cracking is caused by the action of an anesthetic), there is the influence of residual monomers of bisphenol A, and the moldability is inferior to that of a polyvinyl chloride-based resin composition.

Furthermore, it is also known that resins such as α-olefin are used (see Patent Document 1, for example). However, this method is problematic in that the kink resistance (bending resistance) is poor, and, thus, there has been a strong demand for a hard polyvinyl chloride-based resin composition that actually has been used safely for a long period of time in the market; that is made from a polyvinyl chloride-based resin having excellent moldability, chemical resistance, bending resistance, and the like; and that is discolored less due to its excellent radiation resistance.

In order to meet these demands in the medical field, methods for suppressing coloring by adding a stabilizer or an epoxidized vegetable oil (see Patent Documents 2 and 3, for example), or by adding an alkyl mercaptan or an alkyl ester of adipic acid (see Patent Documents 4 and 5, for example) are known. With these methods, the effect is an improvement to some extent in the electron beam sterilization method, but the effect in the γ-ray sterilization method is insufficient, and, thus, it is an urgent task to achieve further improvement.

[Patent Document 1] JP 2003-3026A

[Patent Document 2] JP H8-73619A

[Patent Document 3] JP H8-176383A

[Patent Document 4] JP H7-102142A

[Patent Document 5] JP H11-510854A (Tokuhyo)

### DISCLOSURE OF INVENTION

It is an object of the present invention to provide a resin composition for medical use, resin pellets, and a part for medical use, having excellent radiation resistance in which discoloration significantly is reduced even during sterilization treatment using irradiation with radioactive rays, in particular, γ-rays.

In view of these circumstances, the inventors of the present invention have conducted an in-depth study on the relationship between the radiation resistance (in particular, γ-ray resistance) and polymer materials and additives, and found that the effect of adding a silane compound extremely significantly improves γ-ray resistance, and, thus, the present invention was achieved. In particular, it was found that, in the case of a polyvinyl chloride-based resin composition, γ-ray resistance significantly can be improved, which had been considered to be impossible in a hard composition, and discoloration also significantly can be suppressed in a hard composition, and, thus, the present invention was achieved.

That is to say, the present invention is directed to a resin composition for medical use comprising 0.1 to 15 parts by weight of a silane compound as a radiation resistant agent with respect to 100 parts by weight of a thermoplastic resin.

Furthermore, the present invention is directed to resin pellets comprising the resin composition for medical use.

Furthermore, the present invention is directed to a part for medical use obtained by molding the resin composition for medical use.

### DESCRIPTION OF THE INVENTION

Industrially, a part for medical use obtained by molding the resin composition for medical use of the present invention is extremely useful. The reason for this is that this part for medical use can be sterilized in a short time with a large amount of energy, because it is hardly discolored during sterilization that uses radioactive rays, such as γ-rays.

The thermoplastic resin is preferably at least one resin selected from a polyvinyl chloride-based resin, a polypropylene resin, a polyamide-based resin, a polycarbonate resin, and a 1,2-polybutadiene resin.

The thermoplastic resin is more preferably a polyvinyl chloride-based resin.

The silane compound preferably includes at least one alkoxysilane compound selected from the group consisting of a monoalkoxysilane compound, a dialkoxysilane compound, a trialkoxysilane compound, and a tetraalkoxysilane compound.

The resin composition is preferably a hard composition having a Rockwell hardness (R scale) as defined in JIS K7202 of 35° or more.

The resin composition is preferably a soft composition having a durometer A hardness as defined in JIS K6253 of 97° or less. Thus, the resin of the present invention can be used as both a hard resin and a soft resin.

In the present invention, it is preferable that the thermoplastic resin and the silane compound are melt-blended to form resin pellets and that the molding is performed using the resin pellets. The molding method may be any molding method, such as injection molding, extrusion molding, compression molding, vacuum molding, blow molding, or the like.

Examples of the thermoplastic resin used in the present invention include a polyethylene-based resin, a polypropylene resin, a polyamide-based resin, a polycarbonate resin, a polyacrylic acid-based resin, a polymethacrylic acid-based resin, a polyethylene terephthalate resin, a polybutylene terephthalate resin, an ethylene-vinyl acetate copolymer resin, a polystyrene-based resin, a polybutene resin, a polyisobutene resin, a chlorinated polyethylene resin, a polyvinyl chloride-based resin, a chlorinated polyvinyl chloride resin, a 1,2-polybutadiene resin, a partially crosslinked ethylene-propylene-diene rubber (EPDM), a thermoplastic polyurethane resin, a thermoplastic polyester-based resin, a polycaprolactone-based resin, and the like. Of these resins, a polyvinyl chloride-based resin, a polypropylene resin, a polyamide-based resin, a polycarbonate resin, and a 1,2-polybutadiene resin are preferable because they are materials suitable for medical use, and a polyvinyl chloride-based resin is particularly preferable because it can be used for forming parts ranging from hard parts to soft parts, and has excellent adhesiveness and greatly improved γ-ray resistance (an effect that improves ΔYI).

Here, the polyvinyl chloride-based resin may be any known conventional polyvinyl chloride-based resin, such as a polyvinyl chloride resin obtained from a vinyl chloride homopolymer, or a polyvinyl chloride-based copolymer resin that is obtained by copolymerizing vinyl chloride and another monomer copolymerizable therewith.

Examples of the polyvinyl chloride-based copolymer resin include copolymer resins of vinyl chloride and alkyl vinyl ester, such as a vinyl chloride-vinyl acetate copolymer resin and a vinyl chloride-vinyl stearate copolymer resin; copolymer resins of vinyl chloride and olefins, such as a vinyl chloride-ethylene copolymer resin and a vinyl chloride-propylene copolymer resin; copolymer resins of vinyl chloride and (meth)acrylic acid or its ester; copolymer resins of vinyl chloride and fumaric acid ester; copolymer resins of vinyl chloride and alkyl vinyl ether; and the like. These copolymer resins may be used alone or in a combination of two or more types.

There is no specific limitation on the average degree of polymerization of the polyvinyl chloride-based resin used in the present invention, but the average degree of polymerization is preferably 400 to 1300, and more preferably 650 to 1100, in view of the balance between their processability and their properties. If the average degree of polymerization is 400 or more, impact strength is improved, reducing brittleness, and thus problems in which the part for medical use easily is broken and the like are unlikely to occur. If the average degree of polymerization is 1300 or less, a good balance between the rubber elasticity and the extrusion moldability of the soft composition can be maintained, and the flowability or the like of the hard composition can be prevented from being lowered, and thus injection molding can be easily performed. Accordingly, an average degree of polymerization in this range is preferable.

The silane compound used as the radiation resistant agent in the present invention is at least one silane compound selected from the group consisting of an alkoxysilane compound, a chlorosilane compound, an acetoxysilane compound, and an organosilane compound.

The amount of silane compound added is 0.1 to 15 parts by weight, preferably 1.0 to 7.0 parts by weight, and more preferably 1.5 to 3.5 parts by weight, with respect to 100 parts by weight of the thermoplastic resin. If the amount of silane compound added is 0.1 to 15 parts by weight, the optimum balance between improved radiation resistance, such as γ-ray resistance, other characteristics, the blending cost, and the like can be selected. If the amount is less than 0.1 parts by weight, no significant improvement in radiation resistance is observed. If the amount is more than 15 parts by weight, the effect is not improved further, and bleedout and the like may occur.

Examples of the alkoxysilane compound include: monoalkoxysilane compounds such as trimethylmethoxysilane, trimethylethoxysilane, triethylmethoxysilane, and triethylethoxysilane; dialkoxysilane compounds such as dimethyldimethoxysilane, diethyldimethoxysilane, dimethyldiethoxysilane, diphenyldimethoxysilane, diphenyldiethoxysilane, methylaminoethoxypropyldialkoxysilane, N-(β-aminoethyl)-γ-aminopropylmethyldimethoxysilane, γ-glycidoxypropylmethyldimethoxysilane, and γ-methacryloxypropylmethyldimethoxysilane; trialkoxysilane compounds such as methyltrimethoxysilane, methyltriethoxysilane, hexyltrimethoxysilane, phenyltrimethoxysilane, phenyltriethoxysilane, vinyltrimethoxysilane, vinyltriethoxysilane, γ-chloropropyltrimethoxysilane, γ-aminopropyltriethoxysilane, N-(β-aminoethyl)-γ-aminopropyltrimethoxysilane, N-(phenyl)-γ-aminopropyltrimethoxysilane, γ-glycidoxypropyltrimethoxysilane, 3-methacryloxypropyltrimethoxysilane, 3-methacryloxypropyltriethoxysilane, γ-mercaptopropyltrimethoxysilane, γ-(polyethyleneamino)propyltrimethoxysilane, γ-ureidopropyltriethoxysilane, heptadecafluorodecyltrimethoxysilane, tridecafluorooctyltrimethoxysilane, vinyltris(β-methoxyethoxy)silane, and β-(3,4-epoxycyclohexyl)ethyltrimethoxysilane; and tetraalkoxysilane compounds such as tetramethoxysilane and tetraethoxysilane.

Examples of the acetoxysilane compound include vinyltriacetoxysilane.

Examples of the chlorosilane compound include trimethylchlorosilane, dimethyldichlorosilane, methyltrichlorosilane, vinyltrichlorosilane, and γ-chloropropylmethyldichlorosilane.

The term “organosilane compound” refers to a silane compound in which a group, such as an alkyl group, a vinyl group, a (meth)acrylic group, an allyl group, or a methyl acetate group, is directly bonded to a silicon atom other than the above-described alkoxysilane compound, acetoxysilane compound, or chlorosilane compound. Examples thereof include triisopropylsilane, triisopropylsilyl acrylate, allyltrimethylsilane, and methyl trimethylsilylacetate.

Of these silane compounds, in view of the balance between the radiation resistance and other characteristics, at least one alkoxysilane compound selected from the group consisting of a monoalkoxysilane compound, a dialkoxysilane compound, a trialkoxysilane compound, and a tetraalkoxysilane compound is preferable, a trialkoxysilane compound is more preferable, and 3-methacryloxypropyltrimethoxysilane and 3-methacryloxypropyltriethoxysilane are even more preferable.

Furthermore, in the present invention, these silane compounds also may be used in a combination of two or more types, and there is no particular limitation therein.

Furthermore, in the case where a hard part for medical use is produced, the resin composition for medical use of the present invention has a Rockwell hardness (R scale) as defined in JIS K7202 of preferably 35° or more, and more preferably 60° or more. If a composition having a Rockwell hardness of 35° or more is used in a hard part for medical use, problems in which the part becomes bent, preventing the contained fluid from flowing, do not occur and, for example, good valve properties and tube-connecting operation efficiency can be maintained. Here, the Rockwell hardness (R scale) refers to hardness as defined in JIS K7202 and a value measured according to JIS at a temperature of 23° C.

Furthermore, it is preferable that the Rockwell hardness both before and after γ-ray irradiation is kept at 35° or more. Moreover, the change in hardness (Δhardness) before and after γ-ray irradiation is not particularly limited. However, it is preferable that the change is not so large, and is preferably −2 to 50°. If the change in hardness is within this range, the obtained hard part for medical use can be used without any problem.

Furthermore, in the case where a soft part for medical use is produced, the resin composition for medical use of the present invention has a durometer A hardness as defined in JIS K6253 of preferably 97° or less, and more preferably 70° or less. If a composition having a durometer A hardness of 97° or less is used in a soft part for medical use, appropriate elasticity is obtained, and, thus, the composition preferably can be used in a tube for medical use, a blood bag, an infusion solution bag, and the like. Here, the durometer A hardness refers to hardness as defined in JIS K6253 and a value measured according to JIS at a temperature of 23° C.

Furthermore, it is preferable that the durometer A hardness both before and after γ-ray irradiation is kept at 97° or less. Moreover, the change in hardness (Δhardness) before and after γ-ray irradiation is not particularly limited. However, it is preferable that the change is not so large, and is preferably 0 to 10°. If the change in hardness is within this range, the obtained soft part for medical use can be used without any problem.

In the present invention, known conventional additives may be appropriately used, if necessary, as additives in the thermoplastic resin. Examples of such additives include a plasticizer, a stabilizer, a stabilizing aid, a lubricant, an ultraviolet absorber, an antioxidant, a coloring agent, fillers, and the like.

As such a plasticizer, known conventional plasticizers may be used. Examples thereof include: phthalic acid-based plasticizers such as di-n-butyl phthalate, di-n-octyl phthalate, di-2-ethylhexyl phthalate (DOP), diisooctyl phthalate, dioctyl decyl phthalate, diisodecyl phthalate, butyl benzyl phthalate, and di-2-ethylhexyl isophthalate; fatty acid ester-based plasticizers such as di-2-ethylhexyl adipate, di-n-decyl adipate, dibutyl sebacate, and di-2-ethylhexyl sebacate; phosphoric acid ester-based plasticizers such as tributyl phosphate, tri-2-ethylhexyl phosphate, tri-2-ethylhexyl diphenyl phosphate, and tricresyl phosphate; epoxy-based plasticizers such as epoxidized soybean oil, epoxidized linseed oil, and epoxidized 2-ethylhexyl tall oil fatty acid ester; trimellitic acid ester plasticizers such as tri-2-ethylhexyl trimellitate; citric acid ester plasticizers; and glycolic acid ester plasticizers. These plasticizers may be used alone or in a combination of two or more types if necessary. Of these plasticizers, di-2-ethylhexyl phthalate, diisononyl phthalate, and tri-2-ethylhexyl trimellitate are preferable because they are used preferably for medical use in conventional examples and have excellent γ-ray resistance. Also, an epoxy compound is preferable, and epoxidized linseed oil and epoxidized soybean oil are more preferable, because they have both the function of a plasticizer and the function of a thermal stabilizing aid.

The amount of plasticizer added can be determined as needed, and there is no specific limitation thereon. However, in the case of a soft composition, the amount is preferably 15 to 150 parts by weight with respect to 100 parts by weight of the thermoplastic resin. In the case of a hard composition, the amount is preferably 2 to 15 parts by weight with respect to 100 parts by weight of the thermoplastic resin.

Furthermore, in the present invention, an epoxy compound may be used if necessary. For example, the above-described epoxy-based plasticizers may be used, and known conventional compounds containing epoxy groups also may be used. Examples thereof include various epoxy resins, epoxy unsaturated fatty acid esters, epoxidized polybutadiene, and the Like.

The amount of epoxy compound added is preferably 2 to 25 parts by weight with respect to 100 parts by weight of the thermoplastic resin. Within this range, problems, such as bleeding, do not occur, and a good part for medical use can be produced.

In the resin composition for medical use of the present invention, a known conventional stabilizer or stabilizing aid may be used. A stabilizer is used in order to suppress coloring when applying heat, for example, during molding. A stabilizing aid functions to assist stabilization. These additives may be appropriately selected if necessary.

Examples of the stabilizer that can be added in the present invention include known conventional stabilizers for medical use, such as calcium zinc-based complex stabilizers mainly comprising calcium stearate and zinc stearate, and organic tin-based stabilizers.

In the present invention, organic tin stabilizers are preferable because they have excellent γ-ray resistance. Of these stabilizers, in particular, tin mercapto-based stabilizers such as methyltin mercapto, butyltin mercapto, and octyltin mercapto preferably can be used. Furthermore, an octyltin mercapto-based stabilizer is particularly preferable due to its effect of suppressing discoloration during radiation sterilization and hygiene.

Furthermore, conventional metal soaps for medical use, such as zinc stearate and calcium stearate, also preferably can be used due to their safety and hygiene. Moreover, a stabilizer system in which an octyltin mercapto-based stabilizer, zinc stearate, and calcium stearate are combined is particularly useful, in view of the balance between the various properties of the composition for medical use.

The amount of stabilizer added is preferably 1 to 8 parts by weight with respect to 100 parts by weight of the thermoplastic resin. Within this range, a highly-controlled balance between the radiation resistance, the thermal stability, the elution properties of the stabilizer, and the cost can be obtained.

Known conventional aids may be used as a stabilizing aid. Examples thereof include: phosphites such as dioctyl phosphite, diphenylnonylphenyl phosphite, triphenyl phosphite, tris(nonylphenyl) phosphite, and tridecyl phosphite; phosphates such as triallyl phosphate; and β-diketones such as stearoylbenzoylmethane and dibenzoylmethane.

In the case where the resin composition for medical use of the present invention is used to produce a part for medical use, there is no specific limitation on the production method, and any known conventional production method may be used. For example, a resin composition in which components are blended at a predetermined blending ratio may be pelletized by kneading using a roller, a banbury mixer, an extruder, or the like, and then the obtained pellets may be subjected to molding in various molding machines such as an extrusion molding machine, an injection molding machine, or a calender molding machine.

Known conventional methods may be applied as the blending method. For example, components are mixed by hot blending or cold blending, using a Henschel mixer, a super mixer, or the like. Known conventional methods may be applied as the kneading method. For example, pellets are produced using a single-screw extruder, a different-direction double-screw extruder, a same-direction double-screw extruder, a pressure kneader, a planetary gear extruder, or the like. As for the pelletizing conditions, it is preferable to use a kneader in which the cylinder temperature is set to 100 to 160° C. and the die temperature is set to 130 to 170° C.

Furthermore, in the case where the pellets are subjected to secondary molding, it is preferable to use a molding machine in which the cylinder temperature and the die temperature are set to 130 to 200° C.

The term “part for medical use in the present invention” refers to tools for medical use and their parts, as defined in the Pharmaceutical Affairs Law and Enforcement Ordinance. Specific examples thereof include medical tools such as a blood bag, an infusion solution bag, an effluent bag, an infusion solution set, a blood transfusion set, an apheresis system, a white blood cell-removing filter, an artificial dialysis circuit, a blood circuit system, and an artificial cardiopulmonary system, and their parts for medical use.

A part for medical use in which the hard parts and soft parts are combined can be produced only from a polyvinyl chloride-based material, and this configuration can contribute to the avoidance of problems such as poor adhesion resulting from a combination of different materials, reducing medical troubles caused by such problems as a part falling off, and the like.

### EXAMPLES

Next, the resin composition of the present invention will be described in more detail by way of examples and comparative examples, but the present invention is not limited to these examples.

Hereinafter, the starting materials and evaluation methods used in the examples and the comparative examples will be shown.

### (1) Materials Used

### Resin Component

Polyvinyl chloride resin: Kanevinyl S1007
   manufactured by Kaneka Corporation
Polyvinyl chloride resin: Kanevinyl S1001
   manufactured by Kaneka Corporation
Polypropylene resin: NOVATEC BC6D
   manufactured by Japan Polypropylene Corporation
1,2-Polybutadiene resin: RB-820
   manufactured by JSR Corporation

### Silane Compound

3-Methacryloxypropyltrimethoxysilane:
   manufactured by Shin-Etsu Chemical Co., Ltd.
Tetraethoxysilane:
   manufactured by Shin-Etsu Chemical Co., Ltd.
Chlorotriisopropylsilane:
   manufactured by Sankyo Organic Chemicals Co., Ltd.
Trimethylethoxysilane: manufactured by Toshiba Silicones
Diethyldiethoxysilane: manufactured by Toshiba Silicones
Vinyltriethoxysilane: manufactured by Toshiba Silicones

### Plasticizer Component

Epoxidized soybean oil: manufactured by ADEKA Corporation
Epoxidized linseed oil: manufactured by ADEKA Corporation
Phthalic acid ester plasticizer: manufactured by ADEKA Corporation
Trimellitic acid ester plasticizer:
   manufactured by ADEKA Corporation

### Stabilizer and Stabilizing Aid Component

Organic tin-based stabilizer: dioctyltin dimercaptide
CaZn-based stabilizer: CaZn-based complex stabilizer
Stabilizing aid: organic phosphite

### Lubricant Component

Polyethylene-based lubricant: polyethylene wax
Polymer lubricant: Kane Ace PA-100:
   manufactured by Kaneka Corporation

### (2) Methods for Evaluating Properties and Moldability

### Evaluation of Radiation Resistance

There is no clear standard in JIS or the like for radiation resistance, and, thus, this aspect was evaluated following our own method. First, the yellow index (YI value) before irradiation of a test sample in the shape of a sheet produced by a rolling/pressing treatment was measured using a computer color-matching system (manufactured by Dainichiseika Color & Chemicals Mfg. Co., Ltd.) according to JIS K7105. Then, the test sample was irradiated with γ-rays at 25 kGy. The color of the test sample after irradiation gradually changed to yellow, and, thus, the sample after irradiation was allowed to stand for 3 days at constant temperature and humidity (23° C., 50% relative humidity) until the color stabilized. Subsequently, the YI value of the sample after irradiation was measured using the above measuring system to obtain the YI value after irradiation.

As an index for evaluating the degree of discoloration, the change in yellow index (ΔYI value) defined by the equation below was calculated. Examples 1 to 8 and Comparative Example 1, Examples 9 to 16 and Comparative Example 2, Examples 17 to 23 and Comparative Example 3, Examples 24 to 30 and Comparative Example 4, Example 31 and Comparative Example 5, and Example 32 and Comparative Example 6 were respectively compared, and if the ΔYI value in an example was smaller than that in its respective comparative example, then it was judged that an effect of suppressing discoloration was obtained.

ΔYI value=(YI after irradiation)−(YI before irradiation)

### Rockwell Hardness (R Scale)

Data was collected immediately after measurement at a test temperature of 23° C. using a Rockwell hardness tester according to JIS K7202. As the test piece, a test sample in the shape of a sheet having a thickness of 6 mm was produced by a rolling/pressing treatment, kept in a chamber at constant temperature and humidity (23° C., 50% RH) for one whole day and night, and then subjected to measurement.

### Durometer A Hardness

Data was collected immediately after measurement at a test temperature of 23° C. using a durometer A hardness tester according to JIS K6253. As the test piece, a test sample in the shape of a sheet having a thickness of 6 mm was produced by a rolling/pressing treatment, kept in a chamber at constant temperature and humidity (23° C., 50% RH) for one whole day and night, and then subjected to measurement.

### Examples 1 to 8 and Comparative Example 1

Based on the blend formulations in Table 1, the effects obtained by adding the silane compound to a blending system for hard compositions were checked. The weight of each component was measured, all components were mixed manually together, and the blend was placed in a two-roll mill with a controlled surface temperature of 160° C. and kneaded for 5 minutes. The sheet obtained after rolling was cut into a portion having a predetermined size and treated in a press-molding machine to produce a sheet having a predetermined thickness. The press conditions were such that preheating was performed at 170° C. for 2 minutes, heating was performed for 2 minutes, and then cold-pressing was performed for 5 minutes. Table 1 shows the results obtained by measuring various aspects such as the radiation resistance of the sheet.

TABLE 1

| | | | | | | | | | | Com. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 |
| Polyvinyl chloride resin: S1007 | | 100 | 100 | 100 | 100 | 100 | 100 | 100 | 100 | 100 |
| Organic tin-based stabilizer | | 4.0 | 4.0 | 4.0 | 4.0 | 4.0 | 4.0 | 4.0 | 4.0 | 4.0 |
| Tris(nonylphenyl) phosphite | | 0.3 | 0.3 | 0.3 | 0.3 | 0.3 | 0.3 | 0.3 | 0.3 | 0.3 |
| Lubricant: PE wax | | 1.2 | 1.2 | 1.2 | 1.2 | 1.2 | 1.2 | 1.2 | 1.2 | 1.2 |
| Epoxidized linseed oil | | 15.5 | 15.5 | 15.5 | 15.5 | 15.5 | 15.5 | 15.5 | 15.5 | 15.5 |
| 3- | | 0.1 | 1.5 | 3.5 | 7.0 | 15.0 | — | — | — | — |
| Methacryloxypropyltrimethoxysilane | | | | | | | | | | |
| Tetraethoxysilane | | — | — | — | — | — | 1.5 | 3.5 | — | — |
| Chlorotriisopropylsilane | | — | — | — | — | — | — | — | 3.5 | — |
| Total | | 121.1 | 122.5 | 124.5 | 128.0 | 136.0 | 122.5 | 124.5 | 124.5 | 121.0 |
| Radiation | YI value before γ-ray | 14.51 | 13.46 | 18.73 | 17.86 | 17.23 | 18.95 | 17.63 | 16.37 | 17.58 |
| resistance | irradiation | | | | | | | | | |
| | YI value after γ-ray | 40.11 | 18.35 | 18.91 | 17.00 | 17.25 | 35.88 | 23.35 | 30.48 | 44.74 |
| | irradiation | | | | | | | | | |
| | Change before and after | 25.60 | 4.89 | 0.18 | −0.86 | 0.02 | 16.93 | 5.72 | 14.11 | 27.16 |
| | irradiation (ΔYI) | | | | | | | | | |
| Rockwell | R hardness before γ-ray | 98.7 | 93.1 | 75.5 | 58.2 | 32.1 | 100.5 | 91.2 | 100.6 | 101.4 |
| hardness/ | irradiation (°) | | | | | | | | | |
| hardness | R hardness after γ-ray | 99.4 | 96.5 | 84.4 | 84.3 | 74.2 | 99.4 | 92.3 | 98.9 | 98.6 |
| change | irradiation (°) | | | | | | | | | |
| | Change before and after | 0.7 | 3.4 | 8.9 | 26.1 | 42.1 | −1.1 | 1.1 | −1.7 | −2.8 |
| | irradiation (Δhardness) | | | | | | | | | |

From a comparison between the properties obtained in Comparative Example 1 and Examples 1 to 8, it was seen that ΔYI significantly is reduced as the silane compound is added, to form a composition that will not be discolored by γ-ray irradiation. Conversely, it was seen that the Rockwell hardness after γ-ray irradiation is increased as the silane compound is added, thereby hardening the sheet. It was found that the amount of silane compound added is particularly preferably 0.1 to 15 parts by weight with respect to 100 parts by weight of the polyvinyl chloride resin, in view of the balance between the Rockwell hardness and ΔYI (i.e., the range in which the initial hardness is 35° or more, which is suitable for a hard part for medical use, and ΔYI is small).

Furthermore, from a comparison between Examples 3, 7, and 8, it was seen that the degree of discoloration varies depending on the type of silane compound, and that 3-methacryloxypropyltrimethoxysilane is particularly preferable.

### Examples 9 to 16 and Comparative Example 2

Based on the blend formulations in Table 2, the effects obtained by adding the plasticizer to a blending system for hard compositions, in which the silane compound was blended, were checked. As in Example 1, the weight of each component was measured, all components were mixed manually together, and the blend was placed in a two-roll mill with a controlled surface temperature of 160° C. and kneaded for 5 minutes. The sheet obtained after rolling was cut into a portion having a predetermined size and treated in a press-molding machine to produce a sheet having a predetermined thickness. The press conditions were such that preheating was performed at 170° C. for 2 minutes, heating was performed for 2 minutes, and then cold-pressing was performed for 5 minutes. Table 2 shows the results obtained by measuring various aspects such as the radiation resistance of the sheet.

TABLE 2

| | | | | | | | | | | Com. |
|---|---|---|---|---|---|---|---|---|---|---|
| | | Ex. 9 | Ex. 10 | Ex. 11 | Ex. 12 | Ex. 13 | Ex. 14 | Ex. 15 | Ex. 16 | Ex. 2 |
| Polyvinyl chloride resin: S1007 | | 100 | 100 | 100 | 100 | 100 | 100 | 100 | 100 | 100 |
| Organic tin-based stabilizer | | 3.7 | 3.7 | 3.7 | 3.7 | 3.7 | 3.7 | 3.7 | 3.7 | 3.7 |
| Tris(nonylphenyl) phosphite | | 0.3 | 0.3 | 0.3 | 0.3 | 0.3 | 0.3 | 0.3 | 0.3 | 0.3 |
| Lubricant: PE wax | | 1.5 | 1.5 | 1.5 | 1.5 | 1.5 | 1.5 | 1.5 | 1.5 | 1.5 |
| 3- | | 3.5 | 3.5 | 3.5 | 3.5 | 3.5 | 3.5 | 3.5 | 3.5 | — |
| Methacryloxypropyltrimethoxysilane | | | | | | | | | | |
| Epoxidized linseed oil | | — | 4.0 | 8.0 | 25.0 | — | — | — | 4.0 | — |
| Epoxidized soybean oil | | — | — | — | — | 8.0 | — | — | — | — |
| Di-2-ethylhexyl phthalate | | — | — | — | — | — | 8.0 | — | 4.0 | — |
| Tri-2-ethylhexyl trimellitate | | — | — | — | — | — | — | 8.0 | — | — |
| Total | | 109.0 | 113.0 | 117.0 | 134.0 | 117.0 | 117.0 | 117.0 | 117.0 | 105.5 |
| Radiation | YI value before γ-ray | 14.48 | 19.34 | 15.03 | 16.53 | 20.78 | 16.86 | 17.41 | 15.67 | 19.47 |
| resistance | irradiation | | | | | | | | | |
| | YI value after γ-ray | 83.24 | 76.31 | 44.82 | 16.54 | 25.55 | 19.22 | 30.87 | 24.55 | 153.92 |
| | irradiation | | | | | | | | | |
| | Change before and after | 68.76 | 56.97 | 29.79 | 0.01 | 4.77 | 2.36 | 13.46 | 8.88 | 134.45 |
| | irradiation (ΔYI) | | | | | | | | | |
| Rockwell | R hardness before γ-ray | 102.5 | 107.1 | 99.3 | 2.1 | 100.1 | 96.7 | 104.2 | 96.3 | 108.4 |
| hardness/ | irradiation (°) | | | | | | | | | |
| hardness | R hardness after γ-ray | 101.4 | 105.8 | 102.9 | 21.0 | 104.9 | 104.8 | 110.9 | 102.3 | 106.9 |
| change | irradiation (°) | | | | | | | | | |
| | Change before and after | −1.1 | −1.3 | 3.6 | 18.9 | 4.8 | 8.1 | 6.8 | 6.0 | −1.4 |
| | irradiation (Δhardness) | | | | | | | | | |

From a comparison between the properties obtained in Comparative Example 2 and Examples 9 to 12, it was seen that, as the plasticizer is added to the blending system in which the silane compound is blended, ΔYI is reduced to form a composition that will not be discolored by γ-ray irradiation. Furthermore, from a comparison between Examples 11 and 13 to 15 regarding the type of plasticizer, it was seen that epoxidized soybean oil and DOP are particularly preferable due to their small ΔYI.

From Table 2, it is seen that the optimum amount of plasticizer suitably used in a hard composition is 25 parts or less. Furthermore, from a comparison between Examples 3 and 9 to 12, it was seen that the hardness changes as the amount of plasticizer added increases, but the hardness is suddenly lowered when the amount is around 15 to 25 parts. Thus, it is seen that the optimum amount of plasticizer is more preferably 15 parts or less.

Furthermore, although there was a slight difference in blending ratio, it was seen that the degree of discoloration varies significantly depending on the presence or absence of the epoxy compound (comparison between Comparative Examples 1 and 2), and discoloration significantly is suppressed by simply adding the epoxy compound. In a similar manner, a similar effect was observed in the comparison between Examples 3 and 9, and, thus, it was seen that addition of the epoxy-based plasticizer is effective in improving γ-ray resistance.

### Examples 17 to 23 and Comparative Example 3

Based on the blend formulations in Table 3, the effects obtained by adding various types of silane compounds to a blending system for soft (semi-hard) compositions were checked. As in Example 1, the weight of each component was measured, all components were mixed manually together, and the blend was placed in a two-roll mill with a controlled surface temperature of 160° C. and kneaded for 5 minutes. The sheet obtained after rolling was cut into a portion having a predetermined size and treated in a press-molding machine to produce a sheet having a predetermined thickness. The press conditions were such that preheating was performed at 170° C. for 2 minutes, heating was performed for 2 minutes, and then cold-pressing was performed for 5 minutes. Table 3 shows the results obtained by measuring various aspects such as the radiation resistance of the sheet.

TABLE 3

| | | | | | | | | | Com. |
|---|---|---|---|---|---|---|---|---|---|
| | | Ex. 17 | Ex. 18 | Ex. 19 | Ex. 20 | Ex. 21 | Ex. 22 | Ex. 23 | Ex. 3 |
| Polyvinyl chloride resin: S1001 | | 100 | 100 | 100 | 100 | 100 | 100 | 100 | 100 |
| Phthalic acid-based plasticizer: DOP | | 20 | 20 | 20 | 20 | 20 | 20 | 20 | 20 |
| Stabilizer: CaZn-based stabilizer | | 1.8 | 1.8 | 1.8 | 1.8 | 1.8 | 1.8 | 1.8 | 1.8 |
| Stabilizer: dioctyltin dimercapto | | 0.1 | 0.1 | 0.1 | 0.1 | 0.1 | 0.1 | 0.1 | 0.1 |
| Tris(nonylphenyl) phosphite | | 0.6 | 0.6 | 0.6 | 0.6 | 0.6 | 0.6 | 0.6 | 0.6 |
| Lubricant: PE wax | | 1.4 | 1.4 | 1.4 | 1.4 | 1.4 | 1.4 | 1.4 | 1.4 |
| Polymer lubricant: PA-100 | | 0.5 | 0.5 | 0.5 | 0.5 | 0.5 | 0.5 | 0.5 | 0.5 |
| Epoxidized linseed oil | | 16.0 | 16.0 | 16.0 | 16.0 | 16.0 | 16.0 | 16.0 | 16.0 |
| 3- | | 3.5 | — | — | — | — | 1.0 | 3.0 | — |
| Methacryloxypropyltrimethoxysilane | | | | | | | | | |
| Tetraethoxysilane | | — | 3.5 | — | — | — | — | — | — |
| Triethylethoxysilane | | — | — | 3.5 | — | — | — | — | — |
| Dimethyldiethoxysilane | | — | — | — | 3.5 | — | — | — | — |
| Vinyltriethoxysilane | | — | — | — | — | 3.5 | 3.0 | 1.0 | — |
| Total | | 143.9 | 143.9 | 143.9 | 143.9 | 144.4 | 144.4 | 144.4 | 140.4 |
| Radiation | YI value before γ-ray | 10.07 | 10.32 | 10.27 | 10.24 | 11.92 | 12.34 | 10.87 | 10.66 |
| resistance | irradiation | | | | | | | | |
| | YI value after γ-ray | 10.93 | 11.34 | 11.38 | 11.40 | 10.96 | 13.40 | 11.59 | 22.02 |
| | irradiation | | | | | | | | |
| | Change before and after | 0.86 | 1.02 | 1.11 | 1.16 | 0.96 | 1.06 | 0.72 | 11.36 |
| | irradiation (ΔYI) | | | | | | | | |
| Durometer | A hardness before γ-ray | 90 | 92 | 93 | 92 | 91 | 92 | 89 | 93 |
| hardness/ | irradiation (°) | | | | | | | | |
| hardness | A hardness after γ-ray | 93 | 94 | 94 | 93 | 94 | 95 | 92 | 93 |
| change | irradiation (°) | | | | | | | | |
| | Change before and after | 3 | 2 | 1 | 1 | 3 | 3 | 3 | 0 |
| | irradiation (Δhardness) | | | | | | | | |

Comparative Example 3 is a conventional soft (semi-hard) composition for medical use, and has a relatively small ΔYI. Conversely, from a comparison between Examples 16 to 23, it was seen that, even in the case of the soft (semi-hard) composition, ΔYI becomes significantly smaller than that of Comparative Example 3 as the silane compound is added, to form a composition having excellent γ-ray resistance.

Furthermore, although not so extreme as in the hard composition, it was seen that the durometer A hardness after γ-ray irradiation is increased as the silane compound is added, so hardening the sheet. Although the degree of discoloration varies slightly depending on the type of silane compound, it was seen that 3-methacryloxypropyltrimethoxysilane is particularly preferable due to its excellent discoloration resistance.

Furthermore, it was seen that even in the case where two or more types of silane compound are used together, an effect of improving γ-ray resistance is exerted, and the silane compounds can be freely used together according to the necessity of the characteristics of the part for medical use, the blending cost, and the like.

### Examples 24 to 30 and Comparative Example 4

Based on the blend formulations in Table 4, the effects obtained by adding various types of silane compounds and plasticizers to a blending system for soft compositions were checked. As in Example 1, the weight of each component was measured, all components were mixed manually together, and the blend was placed in a two-roll mill with a controlled surface temperature of 160° C. and kneaded for 5 minutes. The sheet obtained after rolling was cut into a portion having a predetermined size and treated in a press-molding machine to produce a sheet having a predetermined thickness. The press conditions were such that preheating was performed at 170° C. for 2 minutes, heating was performed for 2 minutes, and then cold-pressing was performed for 5 minutes. Table 4 shows the results obtained by measuring various aspects such as the radiation resistance of the sheet.

TABLE 4

| | | | | | | | | | Com. |
|---|---|---|---|---|---|---|---|---|---|
| | | Ex. 24 | Ex. 25 | Ex. 26 | Ex. 27 | Ex. 28 | Ex. 29 | Ex. 30 | Ex. 4 |
| Polyvinyl chloride resin: S1001 | | 100 | 100 | 100 | 100 | 100 | 100 | 100 | 100 |
| Phthalic acid-based plasticizer: DOP | | 35 | 40 | 25 | 25 | 20 | 20 | 20 | 40 |
| Phthalic acid-based plasticizer: DINP | | — | — | 10 | — | 20 | — | 10 | — |
| Trimellitic acid-based plasticizer: | | — | — | — | 10 | — | 20 | 10 | — |
| TOTM | | | | | | | | | |
| Stabilizer: CaZn-based stabilizer | | 1.3 | 1.3 | 1.3 | 1.3 | 1.3 | 1.3 | 1.3 | 1.3 |
| Stabilizer: dioctyltin dimercapto | | 0.1 | 0.1 | 0.1 | 0.1 | 0.1 | 0.1 | 0.1 | 0.1 |
| Tris(nonylphenyl) phosphite | | 0.6 | 0.6 | 0.6 | 0.6 | 0.6 | 0.6 | 0.6 | 0.6 |
| Lubricant: PE wax | | 1.4 | 1.4 | 1.4 | 1.4 | 1.4 | 1.4 | 1.4 | 1.4 |
| Polymer lubricant: PA-100 | | 0.3 | 0.3 | 0.5 | 0.5 | 0.5 | 0.5 | 0.5 | 0.5 |
| Epoxidized linseed oil | | 10.0 | 10.0 | 10.0 | 10.0 | 10.0 | 10.0 | 10.0 | 10.0 |
| 3- | | 2.0 | 2.0 | — | — | — | — | — | — |
| Methacryloxypropyltrimethoxysilane | | | | | | | | | |
| Triethylethoxysilane | | — | — | 3.5 | 3.5 | — | — | — | — |
| Vinyltriethoxysilane | | — | — | — | — | 2.0 | 2.0 | 2.0 | — |
| Total | | 150.7 | 155.7 | 151.7 | 151.7 | 155.7 | 155.7 | 155.7 | 153.7 |
| Radiation | YI value before γ-ray | 11.37 | 10.39 | 11.07 | 10.46 | 11.42 | 11.45 | 10.77 | 10.66 |
| resistance | irradiation | | | | | | | | |
| | YI value after γ-ray | 12.09 | 10.62 | 11.11 | 10.52 | 11.78 | 11.77 | 10.79 | 19.05 |
| | irradiation | | | | | | | | |
| | Change before and after | 0.72 | 0.23 | 0.04 | 0.06 | 0.36 | 0.32 | 0.02 | 8.39 |
| | irradiation (ΔYI) | | | | | | | | |
| Durometer | A hardness before γ-ray | 72 | 68 | 73 | 72 | 69 | 70 | 69 | 73 |
| hardness/ | irradiation (°) | | | | | | | | |
| hardness | A hardness after γ-ray | 73 | 69 | 75 | 74 | 70 | 71 | 70 | 73 |
| change | irradiation (°) | | | | | | | | |
| | Change before and after | 1 | 1 | 2 | 2 | 1 | 1 | 1 | 0 |
| | irradiation (Δhardness) | | | | | | | | |

Comparative Example 4 is a conventional soft composition for medical use and has a relatively small ΔYI. From a comparison between the results of Examples 24 to 30, it was seen that, even in the case where various plasticizers are used together, ΔYI becomes significantly smaller than that of Comparative Example 4 as the silane compound is added, to form a composition having excellent γ-ray resistance.

### Examples 31 and 32 and Comparative Examples 5 and 6

Based on the blend formulations in Table 5, after the silane compound was added to the polypropylene resin or 1,2-polybutadiene resin, the mixture was sufficiently manually mixed, and the blend was subjected to press molding in a press-molding machine to produce a sheet having a predetermined thickness. The press conditions were such that preheating was performed at 160° C. for 2 minutes, heating was performed for 3 minutes, and then cold-pressing was performed for 5 minutes. Table 5 shows the results obtained by measuring various aspects such as the radiation resistance of the sheet.

TABLE 5

| | | | | Com. | |
|---|---|---|---|---|---|
| | | Com. Ex. 5 | Ex. 31 | Ex. 6 | Ex. 32 |
| Polypropylene resin | | 100 | 100 | — | — |
| 1,2-Polybutadiene resin | | — | — | 100 | 100 |
| 3-Methacryloxypropyltrimethoxysilane | | — | 3.5 | — | 3.5 |
| Total | | 100.0 | 103.5 | 100.0 | 103.5 |
| Radiation | YI value before γ-ray | 4.11 | 3.29 | 12.95 | 13.56 |
| resistance | irradiation | | | | |
| | YI value after γ-ray | 7.02 | 5.46 | 72.71 | 40.17 |
| | irradiation | | | | |
| | Change before and after | 2.91 | 2.17 | 59.76 | 26.61 |
| | irradiation (ΔYI) | | | | |
| Rockwell | R hardness before γ-ray | 77.7 | 65.0 | — | — |
| hardness/ | irradiation (°) | | | | |
| hardness change | R hardness after γ-ray | 76.6 | 71.6 | — | — |
| | irradiation (°) | | | | |
| | Change before and after | −1.1 | 6.6 | — | — |
| | irradiation (Δhardness) | | | | |
| Durometer | A hardness before γ-ray | — | — | 91 | 88 |
| hardness/ | irradiation (°) | | | | |
| hardness change | A hardness after γ-ray | — | — | 95 | 86 |
| | irradiation (°) | | | | |
| | Change before and after | — | — | 4 | 8 |
| | irradiation (Δhardness) | | | | |

From a comparison between Comparative Example 5 and Example 31, it was seen that, also in the case where the resin component is a polypropylene resin, ΔYI is reduced and γ-ray resistance is improved by adding the silane compound. Furthermore, it was seen that the Rockwell hardness after γ-ray irradiation is slightly increased as the silane compound is added. Furthermore, from a comparison between Examples 3 and 31, it was seen that, in the case where compositions have different blending ratios but substantially the same Rockwell hardness, the polyvinyl chloride resin has a smaller ΔYI due to the effects obtained by adding the silane compound, that is, it is more suitable to add the silane compound to the polyvinyl chloride resin.

Furthermore, from a comparison between Comparative Example 6 and Example 32, it was seen that, also in the case where the resin component is a 1,2-polybutadiene resin, ΔYI is reduced and γ-ray resistance is improved by adding the silane compound. Furthermore, it was seen that the durometer A hardness after γ-ray irradiation is slightly increased as the silane compound is added. Furthermore, from a comparison between Examples 17 and 32, it was seen that, in the case where compositions have different blending ratios but substantially the same durometer A hardness, the polyvinyl chloride resin has smaller ΔYI due to the effects obtained by adding the silane compound, that is, it is more suitable to add the silane compound to the polyvinyl chloride resin.

1. A resin composition for medical use comprising 0.1 to 15 parts by weight of a silane compound as a radiation resistant agent with respect to 100 parts by weight of a thermoplastic resin.

2. The resin composition for medical use according to claim 1, wherein the thermoplastic resin is at least one resin selected from a polyvinyl chloride-based resin, a polypropylene resin, a polyamide-based resin, a polycarbonate resin, and a 1,2-polybutadiene resin.

3. The resin composition for medical use according to claim 2, wherein the thermoplastic resin is a polyvinyl chloride-based resin.

4. The resin composition for medical use according to claim 1, wherein the silane compound is at least one alkoxysilane compound selected from a monoalkoxysilane compound, a dialkoxysilane compound, a trialkoxysilane compound, and a tetraalkoxysilane compound.

5. The resin composition for medical use according to claim 1, wherein the resin composition is a hard composition having a Rockwell hardness as defined in JIS K7202 of 35° or more.

6. The resin composition for medical use according to claim 1, wherein the resin composition is a soft composition having a durometer A hardness as defined in JIS K6253 of 97° or less.

7. The resin composition for medical use according to claim 1, further comprising a plasticizer.

8. The resin composition for medical use according to claim 7, wherein the plasticizer is contained in an amount of 15 to 150 parts by weight with respect to 100 parts by weight of the thermoplastic resin.

9. The resin composition for medical use according to claim 7, wherein the plasticizer is at least one plasticizer selected from a phthalic acid-based plasticizer, a fatty acid ester-based plasticizer, a phosphoric acid ester-based plasticizer, an epoxy-based plasticizer, a trimellitic acid ester plasticizer, a citric acid ester plasticizer, and a glycolic acid ester plasticizer.

10. The resin composition for medical use according to claim 1, further comprising an epoxy compound.

11. The resin composition for medical use according to claim 10, wherein the epoxy compound is contained in an amount of 2 to 25 parts by weight with respect to 100 parts by weight of the thermoplastic resin.

12. Resin pellets comprising the resin composition for medical use according to claim 1.

13. A part for medical use obtained by molding the resin composition for medical use according to claim 1.
